(19) United States
(12) Patent Application Publication
(10) Pub. No.: US 2002/0101443 A1
(43) Pub. Date: Aug. 1, 2002

(54) Method and apparatus for receiving image files in presentation system

(75) Inventors: Shogo Yamaguchi, Kanagawa (JP); Fumiko Tanaka, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/057,926

(22) Filed: Jan. 29, 2002

(30) Foreign Application Priority Data
Jan. 29, 2001 (JP) 2001-020035

(51) Int. Cl. G09G 5/00

(52) U.S. Cl. 345/730

(57) ABSTRACT

In the presentation system in which images are to be presented to audience during a presentation by a speaker according to image display commands issued by the speaker, a receiving side apparatus stores the image files received from a transmitting side apparatus operated by the speaker, monitors a state of storing the image files in the storage device, and changes at least a part of storing states of the image files stored in the storage device, when it is detected that storing of one image file that is currently received or scheduled to be received from the transmitting side apparatus is impossible, so as to make the storing of the one image file into the storing device possible.

### BACKGROUND OF THE INVENTION

1. Field of the Invention

The present invention relates to an information communication device, and more particularly to a technique suitable for receiving image files at a device with rather limited communication performance, memory capacity, etc.

2. Description of the Related Art

One of the simplest methods for transmitting image files stored in some device to another device is a method for using the “Explorer” of the “Microsoft Windows”. In the Explorer”, the file transfer can be started by dragging an image file stored in a hard disk of a transmission source device and dropping it into a folder of a transmission target device.

Also, in the World Wide Web browsers (which will be referred to as web browsers hereafter) such as the Microsoft Internet Explorer and the Netscape Navigator, a file can be downloaded by specifying a page (a set of files for texts, images, etc.) such that texts and images can be viewed at that device. A file acquired at this point is stored into a cache such that the file can be obtained from the cache in the case of another access to the same page again in order to realize the faster page display. It is possible to set an upper limit for the cache size, and when a newly downloaded file cannot be stored into the cache without exceeding the upper limit, the newly downloaded file is stored into the cache by deleting the earlier downloaded old files.

On the other hand, there is a presentation system in which a transmitting side specifies image files to be transmitted and a receiving side displays received image files, rather than specifying and displaying files at a receiving side as in the Web browser, such as an information processing device proposed in Japanese Patent Application Laid Open No. 10-233772 (1998).

In this presentation system, a speaker plays a role of the file transmitting side and the audience plays a role of the file receiving side. The speaker transmits presentation slides (image files) prepared by the speaker in advance to the audience for the purpose of displaying them. The once received slide file can be stored until the presentation is over rather than deleting it after displaying it at the receiving side such that the earlier slide can be displayed again by sending only a slide display command rather than sending the slide data again, which is an effective measure in the case where the communication speed between the file transmitting and receiving devices is slow. Also, apart from this convenience for re-display, the slides can be transmitted and stored in advance such that the slide display at the audience side can be quickly adjusted by sending only a slide display command when the speaker wishes to change the slides.

Now, when the image file receiving side device is a portable device in which a sufficient file storing region cannot be provided, there can possibly be cases where the desired image files cannot be stored entirely. In such cases, if the file transfer by the “Explorer” is used, the file transfer would simply fail and there would be a need to re-transmit the file after the user has cleaned up the storing region of the receiving side device, which could be quite tedious things to do.

For this reason, it is possible to consider the use of a method for deleting the already displayed old files as used in the Web browser. However, the deletion of the old files would necessitate the re-transmission of the file in the case of displaying the earlier displayed image file again, and this could cause a problem that a very long time would be required for the re-display of the once displayed image file, especially when a low speed communication path is used.

Also, in the case where the presentation slides cannot be stored entirely in the presentation system described above, there is a problem that it becomes impossible to display those presentation slides that could not have been stored.

### BRIEF SUMMARY OF THE INVENTION

It is therefore an object of the present invention to provide method and apparatus for receiving image files in a presentation system which can resolve the conventionally encountered problems noted above.

According to one aspect of the present invention there is provided an apparatus for receiving image files of images to be presented to audience during a presentation by a speaker according to image display commands issued by the speaker using a presentation system, the apparatus comprising: a storage device configured to store the image files received from a transmitting side apparatus operated by the speaker; a monitoring unit configured to monitor a state of storing the image files in the storage device; and a storing state changing unit configured to change at least a part of storing states of the image files stored in the storage device, when the monitoring unit detects that storing of one image file that is currently received or scheduled to be received from the transmitting side apparatus is impossible, so as to make the storing of the one image file into the storing device possible.

According to another aspect of the present invention there is provided a method for receiving image files of images to be presented to audience during a presentation by a speaker according to image display commands issued by the speaker using a presentation system, the method comprising: storing the image files received from a transmitting side apparatus operated by the speaker, into a storage device; monitoring a state of storing the image files in the storage device; and changing at least a part of storing states of the image files stored in the storage device, when the monitoring step detects that storing of one image file that is currently received or scheduled to be received from the transmitting side apparatus is impossible, so as to make the storing of the one image file into the storing device possible.

According to another aspect of the present invention there is provided a computer program product for causing a computer to function as an apparatus for receiving image files of images to be presented to audience during a presentation by a speaker according to image display commands issued by the speaker using a presentation system, the computer program product comprising: a first computer program code for causing the computer to store the image files received from a transmitting side apparatus operated by the speaker; a second computer program code for causing the computer to monitor a state of storing the image files in the storage device; and a third computer program code for causing the computer to change at least a part of storing states of the image files stored in the storage device, when the second computer program code detects that storing of one image file that is currently received or scheduled to be received from the transmitting side apparatus is impossible, so as to make the storing of the one image file into the storing device possible.

According to another aspect of the present invention there is provided a presentation system in which images are to be presented to audience during a presentation by a speaker according to image display commands issued by the speaker, the presentation system comprising: a transmitting side apparatus configured to transmit image files of the images to be presented to the audience; a receiving side apparatus configured to receive the image files from the transmitting side apparatus and present the images of the image files to the audience according to the image display commands issued by the speaker, the receiving side apparatus having: a storage device configured to store the image files received from the transmitting side apparatus operated by the speaker; a monitoring unit configured to monitor a state of storing the image files in the storage device; and a storing state changing unit configured to change at least a part of storing states of the image files stored in the storage device, when the monitoring unit detects that storing of one image file that is currently received or scheduled to be received from the transmitting side apparatus is impossible, so as to make the storing of the one image file into the storing device possible.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of an image file receiving apparatus according to the first embodiment of the present invention in a form of an image display apparatus.

FIG. 2 is a flow chart showing an exemplary processing procedure for an image file receiving operation by the image file receiving apparatus of FIG. 1.

FIG. 3 is a schematic diagram showing an exemplary configuration of a presentation system in which the image file receiving apparatus according to the first embodiment of the present invention is realized in a form of a projector.

### DETAILED DESCRIPTION OF THE INVENTION

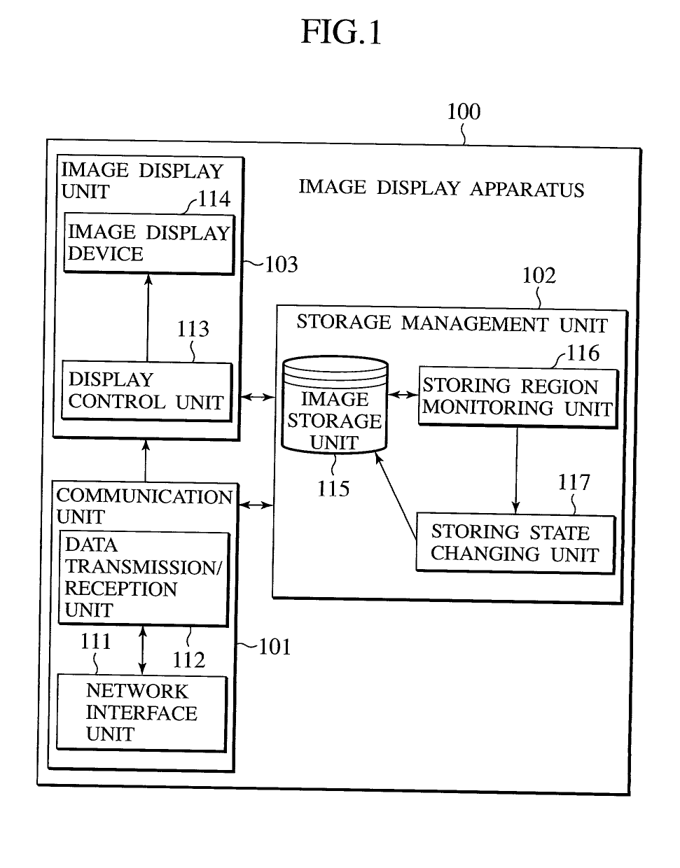

Referring now to FIG. 1 to FIG. 3, the first embodiment of method and apparatus for receiving image files in a presentation system according to the present invention will be described in detail.

1. Overall Configuration

FIG. 1 shows an exemplary configuration of an image file receiving apparatus according to the first embodiment. The first embodiment is directed to an exemplary case of realizing the image file receiving apparatus of the present invention in a form of an image display apparatus.

In FIG. 1, the image display apparatus 100 has at least a communication unit 101, a storage management unit 102, and an image display unit 103. The communication unit 101 has a network interface unit 111 and a data transmission/reception unit 112, the storage management unit 102 has an image storage unit 115, a storing region monitoring unit 116 and a storing state changing unit 117, and the image display unit 103 has a display control unit 113 and an image display device 114.

Here, the network interface unit 111 of the communication unit 101 is a unit for exchanging packets with other devices by a common protocol through a communication device. The communication device and the communication protocol to be used are not limited to any specific ones. For example, it is possible to use a combination of Ethernet and TCP/IP which is most commonly used as a wired LAN, and it is also possible to use a radio LAN instead of Ethernet. Moreover, it is also possible to use a device to be developed in future such as Bluetooth. In essence, anything can be used as long as it is possible to transmit and receive desired data with a desired correspondent. The network interface unit 111 gives packets received from the other device to the data transmission/reception unit 112, and conversely, receives packets to be transmitted from the data transmission/reception unit 112 and transmits these packets to their transmission target devices.

The data transmission/reception unit 112 of the communication unit 101 receives the received packets from the network interface unit 111, extracts received data from these packets and analyze them. Also, when there are data to be transmitted to the other device, the data transmission/reception unit 112 assembles packets incorporating these data. The received data can be the image files or the image display commands. When the received data is the image file, the image file is stored into the image storage unit 115. When a size of the image file is large, the image file may be transmitted in forms of a plurality of packets subdividing the image file, and in such a case, a single image file is reconstructed from the data transmitted in forms of the plurality of packets. On the other hand, when the received data is a image display command, the command data is given to the display control unit 113.

The display control uni 113 of the image display unit 103 is a unit for analyzing the command data given from the data transmission/reception unit 112 of the communication unit 101 and executing that image display command. The image display command can be a display request or a display cancellation. As a method for requesting display, it is possible to specify a “next” image or a “previous” image of the currently displayed image according to an order based on prescribed rules such as “next” and “previous”. or it is possible to specify a name of the image file to be displayed by attaching it to the command. When the image to be displayed is specified by either method, the corresponding image file is acquired from the image storage unit 115, converted into image signals suitable for the image display device 114 and sent to the image display device 114.

The image display device 114 of the image display unit 103 is a device for actually displaying images. It is possible to use a CRT or liquid crystal display device or a projection type device such as a projector. The image display device 114 displays the image signals exactly as received from the display control unit 113.

The image storage unit 115 of the storage management unit 102 is a unit for storing the image files given from the data transmission/reception unit 112 of the communication unit 101. A storage device to be used is not limited to any specific one, and can be a hard disk or a memory.

The storing region monitoring unit 116 of the storage management unit 102 is a unit for checking a utilization state of the image storage unit 115 such as a size of a vacant region, A timing for checking can be set up regularly or at a time of receiving a notice which is to be given from the data transmission/reception unit 112 when the image file is received, or a combination of both. For example, in the case of checking the vacant region regularly, a lower limit for the size of the vacant region is set in advance and, when the vacant region is smaller than the set size at a time of the checking, this fact is notified to the storing state changing unit 117. On the other hand, in the case of receiving the notice from the data transmission/reception unit 112 at a time of the file receiving, a size of the currently received file and a size of a file scheduled to be received from now on are also notified from the data transmission/reception unit 112 and, when the size of files to be received is larger than the size of the vacant region, this fact is notified to the storing state changing unit 117.

The storing state changing unit 117 of the storage management unit 102 is a unit for changing a manner of storing files in the image storage unit 115 upon receiving a notice indicating the shortage of the vacant region size in the storing region from the storing region monitoring unit 116, so as to increase the vacant region size of the storing region in the image storage unit 115 and thereby enabling the storing of the newly received file. Also, the changed storing state is to be notified to the image file transmission source, so that there is a need for the storing state changing unit 117 to give information regarding the changed storing state and the image file transmission source to the data transmission/reception unit 112.

2. Overall Operation

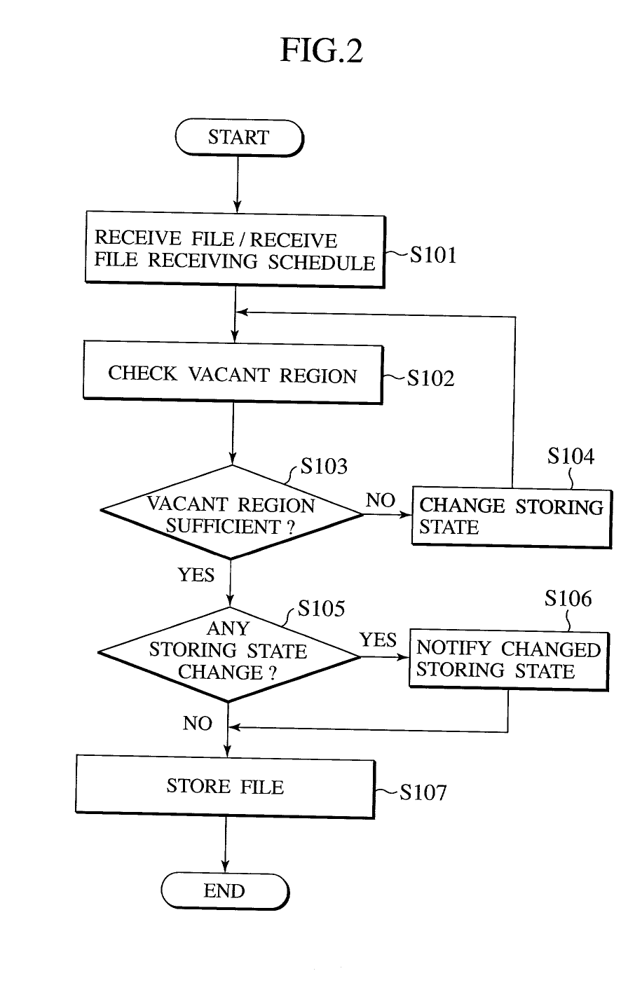

Next, the operation of the image display apparatus 100 shown in FIG. 1 will be described. FIG. 2 shows the processing procedure for the image file receiving operation by this image display apparatus 100. As shown in FIG. 2, when the network interface unit 111 starts receiving the file or receives a file receiving schedule information (step S101), the storing region monitoring unit 116 checks the vacant region size of the file storing region in the image storage unit 115, and judges whether the vacant region size of the image storing region is sufficient for storing the file to be received from now on or not (step S102).

When the vacant region size of the file storing region is insufficient (step S103 NO), the storing state changing unit 117 changes the storing state of the current storing region in the image storage unit 115 (step S104). After the storing state is changed, the processing returns to the step S102 and the steps S102 to S104 described above will be repeated until the vacant region size becomes sufficient.

When the sufficient vacant region size is obtained (step S103 YES), if there is the storing state change at the step S104 (step S105 YES), the storing state changing unit 117 notifies the changed storing state to the image file transmission source through the data transmission/reception unit 112 (step S106). Finally, the newly received image file is stored into the image storage unit 115 (step S107) and the processing is terminated.

In the processing procedure of FIG. 2, the timing for starting the vacant region check of the step S102 is determined according to the timing for start receiving the file or receiving the file receiving schedule at the step S101. On the other hand, in the case of checking the storing region of the image storage unit 115 regularly regardless of whether the file is received or not, the processing of the steps S101 and S107 becomes unnecessary, and the processing will be started by a regular event such as that of a timer or the like.

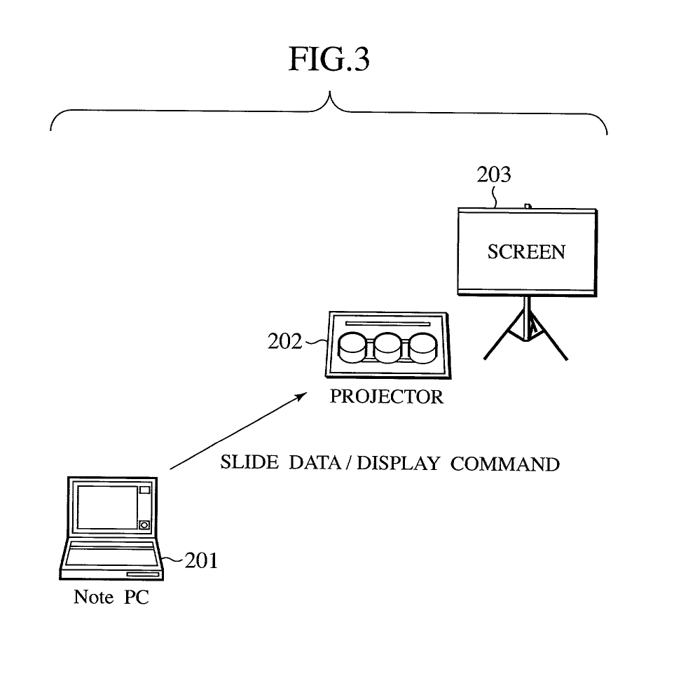

Next, FIG. 3 shows an exemplary presentation system in the case of realizing the image file receiving apparatus of the present invention in a form of an image display apparatus (projector). In the example of FIG. 3, the speaker has his own presentation slides stored in a note PC 201 as image files, one image file per each slide. Then, when the presentation starts, the speaker starts transmitting the slides to a projector 202. All the slides are automatically transmitted to the projector 202 and stored inside the projector 202.

When the speaker carries out an operation for changing slides on the note PC 201, the slide display command is transmitted from the note PC 201 to the projector 202 and the projector 202 executes the received slide display command such that the slide intended by the speaker is displayed on a screen 203. It is possible to enable the transmission of the slide display command even before the transmission of all the slides is completed such that the presentation can be started before the completion of the slide transmission.

When the slide data is transmitted on background in this manner, there can be cases where the slide data are so large that the total size of all the slides exceeds the size of the storing region of the projector 202. In such a case, the shortage of the storing region is detected while transmitting the slides automatically on background and the current storing state is changed so as to secure the vacant region for storing the slides to be received thereafter. The changed storing state is notified to the note PC 201 such that it becomes possible for the note PC 201 side to always comprehend the slide storing state at the projector 202. As a result, it becomes possible to proceed the presentation efficiently by transmitting the slide data according to the slide storing state at the projector 202.

3. Storing State Changing Unit 117

Next, the concrete exemplary operation of the storing state changing unit 117 of FIG. 1 will be described. As described above, the storing state changing unit 117 changes the storing states of the files already stored in the image storage unit 115 upon receiving the storing state changing request from the storing region monitoring unit 116. At a time of this change, how the storing state of which file should be changed is selected/determined according to the circumstance.

As a method for changing the storing state of the file in order to increase the vacant region size of the storing region, there is a method for deleting files. There is also a method for re-storing files by compressing them. For example, the non-compressed files can be compressed, or the already compressed files can be re-stored by using a higher compression rate. In the case of the image files, it is also possible to re-store the image files by contracting images. The method for deleting files can increase the vacant region size of the storing region most, but it will require the re-transmission of all the data in order to re-display the data. In contrast, the method for re-storing by changing the compression rate or contracting images, the vacant region size of the storing region cannot be increased as much as the method for deleting files but the data can be displayed quickly even in the case of re-` display without requiring the re-transmission of the data.

Next, as a method for selecting the storing state changing target files, there is a method for selecting files according to the attributes of the files. The attributes are not limited to any specific ones, but it is possible to use a file name, a file data size, a file format, a reception time, etc. In the case of utilizing the reception time, information on the time at which the file is received is stored in relation to the file at a time of the file receiving. The storing state changing target can be selected sequentially in a sorted order based on the file names, in an ascending order of the reception times, or with a higher priority for a specific format. In the case of utilizing the data size, the storing state changing target can be selected with a higher priority for a file in the larger file size, or conversely with a higher priority for a file in the smaller file size.

It is also possible to determine the priority levels for applying the storing state changing processing at the file transmitting side in advance and attach them at a time of the file transmission. The file receiving side stores the priority level information along with the files, and selects the storing state changing target from those files with the higher priority levels when the storing state changing becomes necessary.

There can be cases where the display of the compressed or contracted images becomes somewhat unclear because of the reduced information compared with the original images depending on the compression rate or the contraction method used. However, the changed storing state at the file receiving side can be notified to the file transmitting side such that, when the file transmitting side desires the display of the compressed or contracted image, the unclear image can be displayed at first for a time being and the original image can be transmitted while displaying the unclear image. It is also possible to require only a difference data in order to recover the original image from the re-stored image such that the amount of data to be re-transmitted can be reduced and the time required until resuming the original clear image display can be reduced.

Next, the concrete exemplary operation of the storing state changing unit 117 of FIG. 1 will be described by using the presentation system shown in FIG. 3. Here, it is assumed that the storing state changing method is the method for deleting files and the method for selecting the storing state changing target files is the method using the file reception times.

Suppose that the storing region of the projector 202 became full so that the next slide file cannot be stored while the slides are automatically transmitted on background. At this point, the already stored slide files with the older reception times are sequentially deleted until the sufficient vacant region for storing the next slide file is created. For example, the slide #0 to the slide #10 have been received sequentially and there is not enough storing region for the next slide #11, the slide #0 is deleted and then the slide #11 is stored. If the deletion of the slide #0 alone is insufficient to create the storing region for the slide #11, more slides can be deleted additionally in an order of slide #1, slide #2, and so on. Note however that those slides which have not been displayed yet are very likely to be displayed thereafter so that the reception of the new slide file may be interrupted if the deletion of such slides becomes necessary.

The information regarding the deleted slide files is notified to the file transmitting source, which is the note PC 201 of the speaker in the case of the presentation system of FIG. 3. In this way, the note PC 201 of the speaker can always comprehend which slides are stored in the projector 202. For example, when the slide that is requested to be displayed by the speaker has been deleted, it is possible to transmit the slide data again without inquiring the projector 202 as to whether the slide data exists or not or receiving a notice regarding the failure of the display command.

Next, the second embodiment of method and apparatus for receiving image files in a presentation system according to the present invention will be described in detail.

In the first embodiment described above, the storing region monitoring unit 116 notifies a result of monitoring the utilization state of the image storage unit 115 to the storing state changing unit 117 within the same apparatus. In other words, in the first embodiment, the receiving side apparatus itself has been dealing with the decrease of the storing region in the image storage unit 115. In contrast, in this second embodiment, a result of monitoring the utilization state of the image storage unit 115 is notified to another apparatus on the transmitting side rather than within the same apparatus. In this way, it becomes possible for the apparatus on the transmitting side to deal with the decrease of the storing region at the receiving side.

For example, the vacant region size of the image storage unit 115 is checked regularly and, when the vacant region size becomes lower than a prescribed size, this fact is notified to the image file transmission source apparatus directly. The notifying target image file transmission source apparatus can be a transmission source of the image file that is most recently stored alone, or all or a part of the transmission sources of the files stored in the image storage unit 115. It is also possible to notify all the apparatuses with which communications are currently possible rather than Just the image file transmission sources.

Instead of checking the vacant region size regularly, it is also possible to check the vacant region size at a time of the start of the image file receiving. In this case, the size of the receiving scheduled file can be notified from the transmitting side such that the other apparatuses are notified only when the vacant region size is smaller than the size of the receiving scheduled file, so as to eliminate any wasteful notification.

As the file receiving apparatus actively notifies the vacant region size to the file transmitting apparatus, it becomes possible for the file transmitting side to carry out the processing according to the vacant region, such as that of the transmission after contracting the image to a size that can be stored into the vacant region or that of the request for deletion of the stored files, for example.

In addition, it is also possible to use both a notification to the storing state changing unit 117 and a notification to the other apparatus for the notification of the vacant region size.

In the case of checking the vacant region regularly, a threshold on the vacant region size for judging whether to notify each of them or not can be the same for all of them or different for different ones. If the same threshold is used, both the receiving side apparatus and the other apparatus will be dealing with the decrease of the storing region simultaneously. If the different thresholds are used, it becomes possible to control which one of the receiving side apparatus and the other apparatus should deal with the decrease of the storing region first when the vacant region size decreases.

Namely, if the threshold for judging the notification to the storing state changing unit 117 is greater than the threshold for judging the notification to the other apparatus, the receiving side apparatus deals with the decrease of the storing region first and the other apparatus also deals with the decrease of the storing region when the dealing at the receiving side apparatus is insufficient so that the vacant region size still decreases further. If the sizes of the thresholds are reversed, the other apparatus deals with the decrease of the storing region first and the receiving side apparatus also deals with the decrease of the storing region when the dealing at the other apparatus is insufficient.

In the case of checking the vacant region according to the receiving scheduled file size, it is also possible to control whether to notify the storing state changing unit 117 of the receiving side apparatus or the other apparatus. If both of them are to be notified, both the receiving side apparatus and the other apparatus will be dealing with the decrease of the storing region simultaneously. It is also possible to use different notification methods according to a difference between the receiving scheduled file size and the vacant region size. For example, both of them can be notified when the receiving scheduled file size is considerably larger than the vacant region size, and only one of them can be notified otherwise.

According to the second embodiment, when the vacant region size of the file storing region at the file receiving apparatus becomes small, it is possible to enable the reception of the new file by dealing with the decrease of the storing region not only at the receiving side apparatus but also at the other apparatus as well.

According to the present invention, when the file storing region of the file receiving apparatus becomes small during the transmission and reception of the image files, it is possible to deal with the decrease of the storing region at the receiving side or the transmitting side automatically, so that it becomes possible to continue the file transmission and reception efficiently without bothering hands of the user.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the image file receiving apparatus of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An apparatus for receiving image files of images to be presented to audience during a presentation by a speaker according to image display commands issued by the speaker using a presentation system, the apparatus comprising:
a storage device configured to store the image files received from a transmitting side apparatus operated by the speaker;
a monitoring unit configured to monitor a state of storing the image files in the storage device; and
a storing state changing unit configured to change at least a part of storing states of the image files stored in the storage device, when the monitoring unit detects that storing of one image file that is currently received or scheduled to be received from the transmitting side apparatus is impossible, so as to make the storing of the one image file into the storing device possible.

2. The apparatus of claim 1, further comprising:
a notification unit configured to notify changes in the storing states made by the storing state changing unit to the transmitting side apparatus when the storing state changing unit changed the storing states.

3. The apparatus of claim 1, wherein the monitoring unit monitors the state of storing the image files in the storage device by checking a vacant capacity in the storing device.

4. The apparatus of claim 3, wherein the monitoring unit also notifies information indicating the vacant capacity in the storage device to the transmitting side apparatus.

5. The apparatus of claim 1, wherein the storing state changing unit changes the storing states by deleting at least a part of the image files stored in the storage device, or compressing at least a part of the image files stored in the storage device and re-storing compressed image files into the storage device, or contracting images of at least a part of the image files stored in the storage device and re-storing image files of contracted images into the storage device.

6. The apparatus of claim 1, wherein the storing state changing unit selects those image files for which the storing states are to be changed, according to attributes of the image files stored in the storage device or prescribed priority levels given to the image files stored in the storage device.

7. A method for receiving image files of images to be presented to audience during a presentation by a speaker according to image display commands issued by the speaker using a presentation system, the method comprising:
storing the image files received from a transmitting side apparatus operated by the speaker, into a storage device;
monitoring a state of storing the image files in the storage device; and
changing at least a part of storing states of the image files stored in the storage device, when the monitoring step detects that storing of one image file that is currently received or scheduled to be received from the transmitting side apparatus is impossible, so as to make the storing of the one image file into the storing device possible.

8. The method of claim 7, further comprising:
notifying changes in the storing states made by the changing step to the transmitting side apparatus when the changing step changed the storing states.

9. The method of claim 7, wherein the monitoring step monitors the state of storing the image files in the storage device by checking a vacant capacity in the storing device.

10. The method of claim 9, wherein the monitoring step also notifies information indicating the vacant capacity in the storage device to the transmitting side apparatus.

11. The method of claim 7, wherein the changing step changes the storing states by deleting at least a part of the image files stored in the storage device, or compressing at least a part of the image files stored in the storage device and re-storing compressed image files into the storage device, or contracting images of at least a part of the image files stored in the storage device and re-storing image files of contracted images into the storage device.

12. The method of claim 7, wherein the changing step selects those image files for which the storing states are to be changed, according to attributes of the image files stored in the storage device or prescribed priority levels given to the image files stored in the storage device.

13. A computer program product for causing a computer to function as an apparatus for receiving image files of images to be presented to audience during a presentation by a speaker according to image display commands issued by the speaker using a presentation system, the computer program product comprising:
a first computer program code for causing the computer to store the image files received from a transmitting side apparatus operated by the speaker;
a second computer program code for causing the computer to monitor a state of storing the image files in the storage device; and
a third computer program code for causing the computer to change at least a part of storing states of the image files stored in the storage device, when the second computer program code detects that storing of one image file that is currently received or scheduled to be received from the transmitting side apparatus is impossible, so as to make the storing of the one image file into the storing device possible.

14. A presentation system in which images are to be presented to audience during a presentation by a speaker according to image display commands issued by the speaker, the presentation system comprising:
a transmitting side apparatus configured to transmit image files of the images to be presented to the audience;
a receiving side apparatus configured to receive the image files from the transmitting side apparatus and present the images of the image files to the audience according to the image display commands issued by the speaker, the receiving side apparatus having:
a storage device configured to store the image files received from the transmitting side apparatus operated by the speaker;
a monitoring unit configured to monitor a state of storing the image files in the storage device; and
a storing state changing unit configured to change at least a part of storing states of the image files stored in the storage device, when the monitoring unit detects that storing of one image file that is currently received or scheduled to be received from the transmitting side apparatus is impossible, so as to make the storing of the one image file into the storing device possible.

15. The presentation system of claim 14, wherein the receiving side apparatus also has:
a notification unit configured to notify changes in the storing states made by the storing state changing unit to the transmitting side apparatus when the storing state changing unit changed the storing states.

16. The presentation system of claim 14, wherein the monitoring unit monitors the state of storing the image files in the storage device by checking a vacant capacity in the storing device.

17. The presentation system of claim 16, wherein the monitoring unit also notifies information indicating the vacant capacity in the storage device to the transmitting side apparatus.

18. The presentation system of claim 14, wherein the storing state changing unit changes the storing states by deleting at least a part of the image files stored in the storage device, or compressing at least a part of the image files stored in the storage device and re-storing compressed image files into the storage device, or contracting images of at least a part of the image files stored in the storage device and re-storing image files of contracted images into the storage device.

19. The presentation system of claim 14, wherein the storing state changing unit selects those image files for which the storing states are to be changed, according to attributes of the image files stored in the storage device or prescribed priority levels given to the image files stored in the storage device.
